(19) United States
(12) Patent Application Publication
(10) Pub. No.: US 2020/0298467 A1
(43) Pub. Date: Sep. 24, 2020

(54) STRUCTURED FILAMENTS USED IN 3D PRINTING

(71) Applicants: COVESTRO LLC, Pittsburgh, PA (US); THE UNIVERSITY OF AKRON, Akron, OH (US)

(72) Inventors: Mukerrem CAKMAK, Lafayette, IN (US); Bryan D. Vogt, Akron, OH (US); Marina Rogunova, Pittsburgh, PA (US); Ernesto Silva Mojica, Cologne (DE); Karl Haider, Wexford, PA (US); Don Wardius, Pittsburgh, PA (US)

(21) Appl. No.: 16/607,127

(22) PCT Filed: Apr. 27, 2017
(86) PCT No.: PCT/US2017/029876

§ 371 Date: Oct. 22, 2019

(51) Int. Cl. B29C 64/118; B33Y 80/00; B33Y 70/00; C08L 75/04

(52) U.S. Cl. CPC B29C 64/118; B33Y 80/00; B29K 2075/00; C08L 75/04; C08L 2207/53; B33Y 70/00

(57) ABSTRACT

3D printing filaments are described herein having core and shell thermoplastic extrudates. Each of the core and shell extrudates have glass transition temperatures, the glass transition temperature of the core being greater than or equal to the glass transition temperature of the shell. The ratio of the viscosity of the core thermoplastic extrudate at printing temperature, over the viscosity of the shell thermoplastic extrudate at printing temperature, is greater than 1, up to 20. The core and shell thermoplastic extrudates are miscible, or compatible with each other, or each comprise a polymer selected from the group consisting of polycarbonates, polyurethanes, polyesters, acrylonitrile butadiene styrene, styrene acrylonitrile, polyalkyl methacrylate, polystyrene, polysulfone, polylactic acid, polyetherimide, and polyimides.

### FIELD OF THE INVENTION

The present invention relates to structured filaments that may be used in three dimensional printing (3D printing), and are made up of at least two different materials in a core/shell configuration.

### BACKGROUND OF THE INVENTION

3D printing has historically been used in rapid prototyping to allow designers to visualize and feel the shape of a product without the costs associated with building a mold. With the development of 3D printing technologies, the quality and properties of 3D printed articles are becoming close to those manufactured by traditional techniques, potentially enabling manufacturers to use them as functional parts. This is especially useful for applications where customization or small lots are desired. 3D printing techniques also allow fabrication of three-dimensional articles of desired geometries in free space. Among the 3D printing techniques, fused filament fabrication (FFF) is one of the most common for printing plastic objects. FFF is popular in the consumer market and for print-at-home applications, but since the polymers available for this technique are limited, its use in industrial applications is not widespread. 3D printing has historically been used in rapid prototyping to allow designers to visualize and feel the shape of a product without the costs associated with building a mold. With the development of 3D printing technologies, the quality and properties of 3D printed articles are becoming close to those manufactured by traditional techniques, potentially enabling manufacturers to use them as functional parts. This is especially useful for applications where customization or small lots are desired. 3D printing techniques also allow fabrication of three-dimensional articles of desired geometries in free space. Among the 3D printing techniques, fused filament fabrication (FFF) is one of the most common for printing plastic objects. FFF is popular in the consumer market and for print-at-home applications, but since the polymers available for this technique are limited, its use in industrial applications is not widespread.

At its core, FFF is based on similar fundamental principles of a basic milling machine, but instead of having a machining head that removes material; it uses a mini plastic extruder to deposit molten polymer extrudate. By programmed x-y-z motions of the extruder head, the desired shape is printed layer-by-layer on a platform as illustrated in FIG. 1. An FFF 3D printer comprises printing element 10 which contains molten extrudate inside of barrel 11 to deposit filament 15 through nozzle 13, which may be deposited upon another filament 16, which was deposited upon bed 17, at speed U, depicted by arrow 19. Heating enclosure 12 ensures the extrudate remains molten, and is deposited at the desired temperature. Filaments 15 and 16 will cool and solidify as the heating elements move further away. Rollers 14 can raise or lower printing element 10, as needed to deposit the filament in the desired location. Printing element 10 may also be moved back and forth, or from side to side, as desired to build a 3D printed object.

In FFF, the molten polymer filaments being printed ideally flow onto the surface of the previously deposited layer and fuse with all adjacent filaments prior to vitrification making a continuous, cohesive part. However, the mechanical strength of the parts printed by FFF is often inferior to those of analogous injection molded parts. One reason for the inferior mechanical strength is the presence of voids or gaps originated from incomplete part filling during the printing process. Moreover, the rapid cooling of the polymer melt and the lack of applied pressure limit the diffusion between adjacent filaments, resulting in poor adhesion at their interfaces and between printed layers. This poor adhesion can manifest itself as composite-like failure of the part with fragmentation of the part along the printed filament lines. FFF printed parts can be considered to have a multitude of polymer weld lines associated with the melding of printed filaments, both side-by-side and top-to-bottom in the part.

In the FFF process, the filament is extruded as a cylinder and thus it must deform in order to generate a cohesive part with minimal voids. High mobility of the polymer in the molten state allows for better diffusion across the interface between the extruded filaments and improves the adhesion between internal weld-lines of the 3D printed part. However, high mobility also may lead to significant deformation of the part in comparison to the digital model, which results in poor dimensional fidelity or even part collapse. Thus, the adhesion at the interface and the fill of the part is generally a compromise with the requirement to maintain the quality and dimensional fidelity of a 3D printed part.

Additionally, the use of traditional molten filaments tends to be highly temperature sensitive. This leads to extremely narrow constraints that are put upon the 3D printer to process the polymer melt, and often the speed and quality of the print are limited in order to maintain this temperature. These narrow constraints limit the conditions in which the 3D printer may operate. These conditions are also known as the processing window. Being able to operate within a broader, or larger, processing window may be beneficial to ensure high quality of the 3D printed part. As temperature fluctuations within the 3D printer become more acceptable, a broad processing window allows for higher flexibility in the printing process and for a broad selection of materials.

### SUMMARY OF THE INVENTION

In one embodiment, a 3D printing filament comprises: a core thermoplastic extrudate, having an outside surface, a glass transition temperature Tg-core, and a viscosity at printing temperature V-core; and a shell thermoplastic extrudate, having an inside and an outside surface, a glass transition temperature Tg-shell, and a viscosity at printing temperature V-shell, wherein the outer surface of the core thermoplastic polymer is in contact with the inner surface of the shell thermoplastic polymer, wherein Tg-core is greater than or equal to Tg-shell, and wherein the ratio of V-core/V-shell is greater than 1 and a maximum of 20, and wherein the core and shell thermoplastic extrudates exhibit miscibility or compatibility with each other.

In another embodiment, a 3D printing filament comprises: a core thermoplastic extrudate, having an outside surface, a glass transition temperature Tg-core, and a viscosity at printing temperature V-core; and a shell thermoplastic extrudate, having an inside and an outside surface, a glass transition temperature Tg-shell, and a viscosity at printing temperature V-shell, wherein the outer surface of the core thermoplastic polymer is in contact with the inner surface of the shell thermoplastic polymer, wherein Tg-core is greater than or equal to Tg-shell, and wherein the ratio of V-core/V-shell is greater than 1 and a maximum of 20, and wherein each of the core and shell thermoplastic extrudates comprise a polymer selected from the group consisting of polycarbonates, polyurethanes, polyesters, acrylonitrile butadiene styrene, styrene acrylonitrile, polyalkyl methacrylate, polystyrene, polysulfone, polylactic acid, polyetherimide, and polyimides.

In yet another embodiment, the 3D printing filament has a Tg-core and Tg-shell between 25° C. and 325° C., preferably between 90° C. and 220° C., most preferably between 1103 and 190° C.

In still another embodiment, the 3D printing filament has a Tg-core that is equal to Tg-shell. In a different embodiment, Tg-core is greater than Tg-shell, in an amount greater than 0° C., up to 100° C., preferably, in an amount between 30° C. and 90° C.

In an alternative embodiment, the 3D printing filament has a ratio of V-core/V-shell between 1 and 15, preferably between 1 and 10.

In an embodiment not yet disclosed, the filament comprises 35%-75% core thermoplastic extrudate, preferably 45%-55% core thermoplastic extrudate.

In a different embodiment, substantially all of the inner surface of the shell thermoplastic polymer is in contact with the outer surface of the core. In another, substantially all of the outer surface of the core thermoplastic polymer is in contact with the inner surface of the shell thermoplastic polymer.

In another embodiment, the core and shell thermoplastic extrudates each have a crystallinity of 10% or less.

### BRIEF DESCRIPTION OF THE FIGURES

The present invention will now be described for purposes of illustration and not limitation in conjunction with the figures, wherein:

FIG. 1 shows a schematic of a 3-D printer in operation;

FIG. 2 shows a schematic of a printing element of a 3-D printer in operation;

FIG. 3 shows a schematic of a co-extrusion system;

FIG. 4 shows a perspective view of a structured core-shell filament;

FIG. 5 shows a perspective view of several printed extruded filaments;

FIG. 6 shows a top view of a 3-D printed sample;

FIG. 7 shows a side view of a 3-D printed sample; and

FIG. 8 shows a graph of three resin systems over a range of temperatures, and showing their respective glass transition temperatures.

### DESCRIPTION OF THE INVENTION

To overcome the compromise in printing three-dimensional parts by FFF, structured filaments comprising of two or more thermoplastic components are extruded in a core-shell configuration and are used as the feed filament for a 3D printer. These thermoplastic components are selected to exhibit differences in the glass transition temperature (Tg) of the core and shell (Tg-core and Tg-shell) as well as in the melt viscosity (V) of the core and shell (V-core and V-shell) to promote both interdiffusion of the so-called “shell” polymers at the weld lines between the layers, and maintain the dimensional fidelity of the printed part. As illustrated in FIG. 2, 3D printing element 20 comprises barrel 21, heating enclosure 22 and nozzle 23. Inside barrel 21 is structured filament 28 comprising core 24 and shell 25. Structured filament 28 is constricted at nozzle 23 to form extruded filament 26, which is deposited on bed 27. Core 24 and Shell 25 are extruded together in a core-shell configuration, resulting in a structured filament having a viscosity ratio Vᵣₐₜᵢₒ (Vᵣₐₜᵢₒ=V-core/V-shell) as well as a difference in glass transition temperature ΔTg (ΔTg=Tg-core−Tg-shell) between the core and the shell polymers. These differences lead to a synergistic benefit associated with the lower viscosity and Tg of the shell compared to those of the core. The high viscosity and high Tg of the core serve as a reinforcement that maintains the dimensional fidelity of the part being printed. The lower viscosity of the shell enhances the flow of the structured filament and promotes interdiffusion between the filament layers, therefore increasing part filling and minimizing or eliminating voids. The core-shell filaments are manufactured, for example, via co-extrusion of two different thermoplastic polymers (or different grades of the same polymer). In particular, Polycarbonate (PC), PC-copolymer, and PC/acrylonitrile butadiene styrene (ABS) blends were considered as thermoplastics of interest for formulating the core-shell filaments.

1. Thermoplastic Compositions

The filaments of the present invention comprise thermoplastic compositions such as polycarbonate resins, copolymers, blends of polycarbonates with other compatible polymers, and optionally additives thereto.

Suitable polycarbonate resins for preparing the filaments of the present invention are homopolycarbonates, copolycarbonates, and/or polyestercarbonates. These polycarbonate resins may be either linear or branched resins or mixtures thereof. Polycarbonate blends that may be used in association with the present invention include polycarbonate/acrylonitrile butadiene styrene (PC/ABS), PC/polyester and PC/thermoplastic polyurethane.

A portion of up to 80 mol %, preferably of 20 mol % up to 50 mol %, of the carbonate groups in the polycarbonates used in accordance with the invention may be replaced by aromatic dicarboxylic ester groups. Polycarbonates of this kind, incorporating both acid radicals from the carbonic acid and acid radicals from aromatic dicarboxylic acids in the molecule chain, are referred to as aromatic polyestercarbonates. In the context of the present invention, they are encompassed by the umbrella term of the thermoplastic aromatic polycarbonates.

The polycarbonates are prepared in a known manner from bishydroxyaryl compounds, carbonic acid derivatives, optionally chain terminators and optionally branching agents. The polyestercarbonates are prepared by replacing a portion of the carbonic acid derivatives with aromatic dicarboxylic acids or derivatives of the dicarboxylic acids. Dihydroxyaryl compounds suitable for the preparation of polycarbonates are those of the formula (2)

HO—Z—OH (2),

in which
Z is an aromatic radical which has 6 to 30 carbon atoms and may contain one or more aromatic rings, may be substituted and may contain aliphatic or cycloaliphatic radicals or alkylaryls or heteroatoms as bridging elements.

Preferably, Z in formula (2) is a radical of the formula (3)

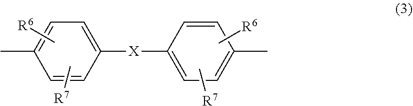

in which

R⁶ and R⁷ are each independently H, C₁- to C₁₈-alkyl-, C₁- to C₁₈-alkoxy, halogen such as Cl or Br or in each case optionally substituted aryl or aralkyl, preferably H or C₁- to C₁₂-alkyl, more preferably H or C₁- to C₈-alkyl and most preferably H or methyl, and

X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else C₆- to C₁₂-arylene which may optionally be fused to further aromatic rings containing heteroatoms.

Preferably, X is a single bond, C₁- to C₅-alkylene, C₂- to C₅-alkylidene, C₅- to C₆-cycloalkylidene, —O—, —SO—, —CO—, —S—, —SO₂—

or a radical of the formula (3a)

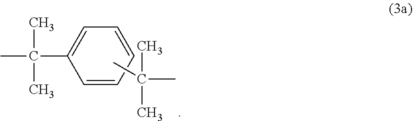

Examples of dihydroxyaryl compounds (diphenols) are: dihydroxybenzenes, such as include hydroquinone, resorcinol, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulphides, bis(hydroxyphenyl) sulphones, bis(hydroxyphenyl) sulphoxides, 1,1′-bis(hydroxyphenyl)diisopropylbenzenes and the alkylated and ring-alkylated and ring-halogenated compounds thereof.

Preferred bishydroxyaryl compounds are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane (BPA), 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred bishydroxyaryl compounds are 4,4′-dihydroxydiphenyl, 1,1-bis(4-hydroxyphenyl)phenylethane, 2,2-bis(4-hydroxyphenyl)propane (BPA), 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

These and further suitable bishydroxyaryl compounds are described, for example, in U.S. Pat. No. 2,999,835 A, 3 148 172 A, 2 991 273 A, 3 271 367 A, 4 982 014 A and 2 999 846 A, in German published specifications 1 570 703 A, 2 063 050 A, 2 036 052 A, 2 211 956 A and 3 832 396 A, in French patent 1 561 518 A1, in the monograph “H. Schnell, Chemistry and Physics of Polycarbonates, Interscience Publishers, New York 1964, p. 28 ff.; p. 102 ff.”, and in “D. G. Legrand, J. T. Bendler, Handbook of Polycarbonate Science and Technology, Marcel Dekker New York 2000, p. 72ff.”

Only one bishydroxyaryl compound is used in the case of the homopolycarbonates; two or more bishydroxyaryl compounds are used in the case of copolycarbonates. The bishydroxyaryl compounds employed, similarly to all other chemicals and reagents used in the synthesis may be contaminated with the byproducts from their own synthesis, handling and storage. However, it is desirable to employ the purest possible raw materials.

The monofunctional chain terminators needed to regulate the molecular weight, such as phenols or alkylphenols, especially phenol, p-tert-butylphenol, isooctylphenol, cumylphenol, the chlorocarbonic esters thereof or acid chlorides of monocarboxylic acids or mixtures of these chain terminators, are either supplied to the reaction together with the bisphenoxide(s) or else added to the synthesis at any time, provided that phosgene or chlorocarbonic acid end groups are still present in the reaction mixture, or, in the case of the acid chlorides and chlorocarbonic esters as chain terminators, provided that sufficient phenolic end groups of the polymer being formed are available. Preferably, the chain terminator(s), however, is/are added after the phosgenation at a site or at a time when no phosgene is present any longer but the catalyst has still not been metered in, or are metered in prior to the catalyst, together with the catalyst or in parallel.

Any branching agents or branching agent mixtures to be used are added to the synthesis in the same manner, but typically before the chain terminators. Typically, trisphenols, tetraphenols or acid chlorides of tri- or tetracarboxylic acids are used, or else mixtures of the polyphenols or of the acid chlorides.

Some of the compounds having three or more than three phenolic hydroxyl groups that are usable as branching agents are, for example, phloroglucinol, 4,6-dimethyl-2,4,6-tri(4-hydroxyphenyl)hept-2-ene, 4,6-dimethyl-2,4,6-tri-(4-hydroxyphenyl)heptane, 1,3,5-tris(4-hydroxyphenyl)benzene, 1,1,1-tri-(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of any branching agents to be used is 0.05 mol % to 2 mol %, again based on moles of bishydroxyaryl compounds used in each case.

The branching agents can either be initially charged together with the bishydroxyaryl compounds and the chain terminators in the aqueous alkaline phase or added dissolved in an organic solvent prior to the phosgenation.

All these measures for preparation of the polycarbonates are familiar to those skilled in the art.

Aromatic dicarboxylic acids suitable for the preparation of the polyestercarbonates are, for example, orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulphone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids are the dicarbonyl dihalides and the dialkyl dicarboxylates, especially the dicarbonyl dichlorides and the dimethyl dicarboxylates.

The replacement of the carbonate groups by the aromatic dicarboxylic ester groups proceeds essentially stoichiometrically and also quantitatively, and so the molar ratio of the co-reactants is reflected in the final polyester carbonate. The aromatic dicarboxylic ester groups can be incorporated either randomly or in blocks.

Preferred modes of preparation of the polycarbonates for use in accordance with the invention, including the polyestercarbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In the first case, the acid derivatives used are preferably phosgene and optionally dicarbonyl dichlorides; in the latter case, they are preferably diphenyl carbonate and optionally dicarboxylic diesters. Catalysts, solvents, workup, reaction conditions etc. for the polycarbonate preparation or polyestercarbonate preparation have been described and are known to a sufficient degree in both cases.

The thermoplastic composition may also include a blend of polycarbonate and/or copolymer, along with additional polymers based on vinyl monomers such as vinyl aromatic compounds and/or vinyl aromatic compounds substituted on the ring (such as styrene, α-methylstyrene, p-methylstyrene, p-chlorostyrene), methacrylic acid (C₁-C₈)-alkyl esters (such as methyl methacrylate, ethyl methacrylate, 2-ethylhexyl methacrylate, allyl methacrylate), acrylic acid (C₁-C₈)-alkyl esters (such as methyl acrylate, ethyl acrylate, n-butyl acrylate, tert-butyl acrylate), polybutadienes, butadiene/styrene or butadiene/acrylonitrile copolymers, polyisobutenes or polyisoprenes grafted with alkyl acrylates or methacrylates, vinyl acetate, acrylonitrile and/or other alkyl styrenes, organic acids (such as acrylic acid, methacrylic acid) and/or vinyl cyanides (such as acrylonitrile and methacrylonitrile) and/or derivatives (such as anhydrides and imides) of unsaturated carboxylic acids (for example maleic anhydride and N-phenyl-maleimide). These vinyl monomers can be used on their own or in mixtures of at least two monomers. Preferred monomers in the copolymer can be selected from at least one of the monomers styrene, methyl methacrylate, n-butyl acrylate, acrylonitrile, butadiene, and styrene.

A process for producing blends of polycarbonates and rubber modified graft polymers, the latter being produced by the mass- or solution (emulsion) polymerization process, characterized in that oligocarbonates (A) and rubber modified graft polymers (B) are mixed in the melt, and in the process the oligocarbonates are condensed under reduced pressure to form high molecular weight polycarbonate.

Suitable rubbers (B) for the rubber-modified graft polymers (B) include diene rubbers and EP(D)M rubber, for example, i.e. those based on ethylene/propylene and optionally diene, acrylate, polyurethane, silicone, chloroprene and ethylene/vinyl acetate rubbers.

Preferred rubbers B comprise diene rubbers (e.g. those based on butadiene, isoprene, etc.) or mixtures of diene rubbers or copolymers of diene rubbers or their mixtures with other copolymerizable monomers, with the proviso that the glass transition temperature of component B is less than 10° C., preferably less than −10° C. Pure polybutadiene rubber is particularly preferred.

If necessary, and if the rubber properties of component B are not impaired thereby, component B may in addition contain small amounts, usually less than 5 weight % and preferably less than 2 weight % based on B, of ethylenically unsaturated monomers with a cross-linking effect. Examples of such monomers with a cross-linking effect include alkylenediol di(meth)acrylates, polyester di(meth)acrylates, divinylbenzene, trivinylbenzene, triallyl cyanurate, allyl (meth)acrylate, diallyl maleate and diallyl fumarate.

Various polyesters can be used as the thermoplastic polyester in this invention, but thermoplastic polyesters obtained by polymerizing bifunctional carboxylic acids and diol ingredients are particularly preferred. Aromatic dicarboxylic acids, for example, terephthalic acid, isophthalic acid, naphthalene dicarboxylic acid and the like, can be used as these bifunctional carboxylic acids, and mixtures of these can be used as needed. Among these, terephthalic acid is particularly preferred from the standpoint of cost. Also, to the extent that the effects of this invention are not lost, other bifunctional carboxylic acids such as aliphatic dicarboxylic acids such as oxalic acid, malonic acid, adipic acid, suberic acid, azelaic acid, sebacic acid, decane dicarboxylic acid, and cyclohexane dicarboxylic acid; and their ester-modified derivatives can also be used.

As diol ingredients those commonly used in the manufacture of polyesters can be used. Suitable examples include, straight chain aliphatic and cycloaliphatic diols having 2 to 15 carbon atoms, for example, ethylene glycol, propylene glycol, 1,4-butanediol, trimethylene glycol, tetramethylene glycol, neopentyl glycol, diethylene glycol, cyclohexane dimethanol, heptane-1,7-diol, octane-1,8-diol, neopentyl glycol, decane-1,10-diol, etc,; polyethylene glycol; bivalent phenols such as (bishydroxyarylalkanes such as 2,2-bis(4-hydroxylphenyl)propane (bisphenol-A), bis(4-hydroxyphenyl) methane, bis(4-hydroxyphenyl)naphthylmethane, bis(4-hydroxypheylphenylmethane, bis-4-hydroxyphenyl 4-isopropylphenyl) methane, bis(3,5-dichloro-4-hydroxyphenyl) methane, bis(3,5-dimethyl-4-hydroxyphenyl)methane, 1,1-bis-(4-hydroxyphenyl)ethane, 1-naphthyl-1,1-bis(4-hydroxyphenyl)ethane, 1-phenyl-1,1-bis(4-hydroxyphenyl) ethane, 1,2-bis(4-hydroxyphenyl)ethane, 2-methyl-1,1-bis(4-hydroxyphenyl) propane, 2,2-bis(3,5-dimethyl-4-hydroxyphenyl)propane, 1-ethyl-1,1-bis(4-hydroxyphenyl) propane, 2,2-bis(3,5-dichloro-4-hydroxyphenyl)propane, 2,2-bis(3,5-dibromo-4-hydrozyphenyl)propane, 2,2-bis(3-chloro-4-hydroxyphenyl)propane, 2,2-bis(3-methyl-4-hydroxyphenyl) propane, 2,2-bis(3-fluoro-4-hydroxyphenyl) propane, 1,1-bis(4-hydroxyphenyl)butane, 2,2-bis(4-hydroxyphenyl)butane, 1,4-bis(4-hydroxyphenyl)butane, 2,2-bis(4-hydroxyphenyl)pentane, 4-methyl-2,2-bis(4-hydroxyphenyl) pentane, 2,2-bis(4-hydroxyphenyl)hexane, 4,4-bis(4-hydroxyphenyl)heptane, 2,2-bis(4-hydroxyphenyl) nonane, 1,10-bis(4-hydroxyphenyl)decane, 1,1-bis(4-hydroxyphenyl)3,3,5-trimethylcyclohexane, and 2,2-bis(4-hydroxyphenyl)-1,1,1,3,3,3-hexafluoropropane; dihyroxydiarylcycloalkanes such as 1,1-bis(4-hydroxyphenyl) cyclohexane, 1,1-bis(3,5-dichloro-4-hydroxyphenyl)cyclohexane, and 1,1-bis(4-hydroxyphenyl)cyclodecane; dihydroxydiarylsulfones such as bis(4-hydroxyphenyl)sulfone, and bis(3,5-dimethyl-4-hydroxyphenyl)sulfone, bis(3-chloro-4-hydroxyphenyl)sulfone; dihydroxydiarylethers such as bis(4-hydroxyphenyl)ether, and bis(3-5-dimethyl-4-hydroxyphenyl)ether; dihydroxydiaryl ketones such as 4,4′-dihydroxybenzophenone, and 3,3′, 5,5′-tetramethyl-4,4-diydroxybenzophenone; dihydroxydiaryl sulfides such as bis(4-hydroxyphenyl)sulfide, bis(3-methyl-4-hydroxyphenyl) sulfide, and bis(3,5-dimethyl-4-hydroxyphenyl)sulfide; dihydroxydiaryl sulfoxides such as bis(4-hydroxyphenyl) sulfoxide; dihydroxydiphenyls such as 4,4′-dihydroxyphenyl; dihydroxyarylfluorenes such as 9,9-bis(4-hydroxyphenyl) fluorene; dihydroxybenzenes such as hydroxyquinone, resorcinol, and methylhydroxyquinone; and dihydroxynaphthalenes such as 1,5-dihydroxynaphthalene and 2,6-dihydroxynaphthalene. Also, two or more types of diols can be combined as needed.

In a specific embodiment, the polyester is polyethylene terephthalate, polybutylene terephthalate, polyethylene naphthalate, polybutylene naphthalate, polytrimethylene terephthalate, poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), or a combination comprising at least one of the foregoing polyesters. Polyethylene terephthalate (PET) and polytrimethylene terephthalate (PTT) are particularly suitable as the polyester in the invention. Thermoplastic polyesters can be produced in the presence or absence of common polymerization catalysts represented by titanium, germanium, antimony or the like; and can be produced by interfacial polymerization, melt polymerization or the like.

Thermoplastic polyurethane elastomers (TPU) can serve as blend partners in the thermoplastic filaments of the invention. Suitable TPU are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 75 Shore D.

Thermoplastic polyurethanes can be produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of the suitable polyols include difunctional polyether polyols, polyester polyols, and polycarbonate polyols. Small amounts of trifunctional polyols may be used, yet care must be taken to make certain that the thermoplasticity of the thermoplastic polyurethane remains substantially un-effected.

Suitable polyester polyols include the ones which are prepared by polymerizing ε-caprolactone using an initiator such as ethylene glycol, ethanolamine and the like. Further suitable examples are those prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); 1,6-hexanediol; 1,8-octanediol; neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes useful in the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof.

Preferred chain extenders with molecular weights of 62 to 500 include aliphatic diols containing 2 to 14 carbon atoms, such as 1,2-ethanediol (ethylene glycol), 1,6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(ß-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, for example, and aromatic diamines, such as toluene 2,4- and 2,6-diamines, 3,5-diethyltoluene 2,4- and/or 2,6-diamine, and primary ortho-, di-, tri- and/or tetraalkyl-substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

In order to prepare the thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, preferably 0.95:1.0 to 1.10:1.0.

Suitable catalysts include tertiary amines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol. %, based on moles of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for instance, from Covestro LLC, Pittsburgh, Pa. under the TEXIN trademark. The thermoplastic polyurethane is present in the thermoplastic blend in from preferably 5-10 percent by weight of the combined weights of the thermoplastic aromatic polycarbonate and thermoplastic polyurethane present.

The production of the compositions useful in the present invention may be carried out in standard mixing units, particularly extruders and kneaders. All components may be mixed all at once or, as required, stepwise.

This compounding may be combined with the incorporation of auxiliaries, reinforcing materials and/or pigments suitable for polycarbonates, polyurethanes and/or graft polymers, although such additives may also be separately incorporated in the molding compounds and/or components. Individual examples of such additives include inter alia glass fibers, carbon fibers, fibers of organic and inorganic polymers, calcium carbonate, talcum, silica gel, quartz powder, flow aids, mold release agents, stabilizers, carbon black and TiO2.

Alternatively the thermoplastic composition may comprise other amorphous or semicrystalline thermoplastic polymers, such as polyurethanes, polyesters, acrylonitrile butadiene styrene, styrene acrylonitrile, polyalkyl methacrylate, polystyrene, polysulfone, polylactic acid, polyetherimide, polyamides and polyimides.

The thermoplastic composition may optionally comprise one or more commercially available polymer additives such as flame retardants, flame retardant synergists, anti-dripping agents (for example compounds of the substance classes of the fluorinated polyolefins, of the silicones as well as aramid fibers), lubricants and mold release agents (for example pentaerythritol tetrastearate), nucleating agents, stabilizers, antistatic agents (for example conductive blacks, carbon fibers, carbon nanotubes as well as organic antistatic agents such as polyalkylene ethers, alkylsulfonates or polyamide-containing polymers), as well as colorants and pigments.

As noted above the polymer additives may include flame retardants, preferably phosphorus-containing flame retardants, in particular selected from the groups of the monomeric and oligomeric phosphoric and phosphonic acid esters, phosphonate amines and phosphazenes. The additives may also comprise a mixture of a plurality of components selected from one or more of these groups to be used as flame retardants. It is also possible to use other, preferably halogen-free phosphorus compounds that are not mentioned specifically here, on their own or in arbitrary combination with other, preferably halogen-free phosphorus compounds. Suitable phosphorus compounds include, for example: tributyl phosphate, triphenyl phosphate, tricresyl phosphate, diphenylcresyl phosphate, diphenyloctyl phosphate, diphenyl-2-ethylcresyl phosphate, tri-(isopropylphenyl) phosphate, resorcinol-bridged di- and oligo-phosphate, and bisphenol A-bridged di- and oligo-phosphate. The use of oligomeric phosphoric acid esters derived from bisphenol A is particularly preferred. Phosphorus compounds that are suitable as flameproofing agents are known (see e.g. EP-A 0 363 608, EP-A 0 640 655) or can be prepared by known methods in an analogous manner (e.g. Ullmanns Enzyklopädie der technischen Chemie, Vol. 18, p. 301 ff 1979; Houben-Weyl, Methoden der organischen Chemie, Vol. 12/1, p. 43; Beilstein Vol. 6, p. 177).

The polymer additives may further contain additional optional additives known to those in the art, such as, for example, antioxidants, UV absorbers, light absorbers, fillers, reinforcing agents, additional impact modifiers, plasticizers, optical brighteners, pigments, dyes, colorants, blowing agents, and combinations of any thereof.

Suitable thermoplastic compositions comprising polycarbonate resins are available in commerce, for instance, from Covestro LLC, Pittsburgh, Pa., under the MAKROLON, BAYBLEND, MAKROBLEND, TEXIN and APEC trademarks.

The thermoplastic compositions of the present inventions are preferably amorphous or semicrystalline materials with glass transition temperatures Tg between 250° C. and 3000° C. and crystallinity of less than 5% as measured by DSC (Differential Scanning Calorimetry).

The difference in Tg of the core and shell results in significantly different viscosity of the shell compared to that of the core at the printing temperature, offering processing advantages for fabricating three-dimensional objects via FFF.

The melting of a crystalline solid or boiling of a liquid is associated with a change of phase and the involvement of latent heat. Many high polymers possess enough molecular symmetry and/or structural regularity that they crystallize sufficiently to produce a solid-liquid phase transition, exhibiting a crystalline melting point. The melting is quite sharp for some polymers such as nylons, while in other cases such as for different rubbers, the phase change takes place over a range of temperature. Phase transitions of this kind, particularly in low molecular weight materials, are associated with sharp discontinuities in some primary physical properties, such as the density or volume, and entropy. This phase transition is commonly termed a first order transition. The glass transition (Tg) is a second order transition and unlike a phase transition it involves no latent heat. Below the Tg polymers are rigid, and dimensionally stable and they are considered to be in a glassy state. Above the Tg, polymers are soft and flexible, and become subject to cold flow or creep and are in what is termed a rubbery state. The difference between the rubbery and glassy states does not lie in their geometrical structure, but in the state and degree of molecular motion.

The thermoplastic compositions of the core-shell structured filaments of the present invention should be miscible or compatible with one another. Without being bound by theory, miscibility and compatibility are each believed to provide better interdiffusion at the core-shell interface which results in improved adhesion between the core and shell layers.

Two thermoplastic compositions may be miscible, compatible, or fully immiscible. Miscible compositions are described by ΔHm<0 due to specific interactions. Homogeneity is observed at least on a nanometer scale, if not on the molecular level. This type of compositions exhibit only one glass transition temperature (Tg), which is in between the glass transition temperatures of the original components. A well-known example of a composition, which is miscible over a very wide temperature range and in all proportions, is polystyrene/poly (2,6-dimethyl-1,4-phenylene oxide (PS/PPO).

Compatible thermoplastic compositions occur when a part of one of the component is dissolved in the other. This type of composition, which exhibits a fine phase morphology and satisfactory properties, is referred to as compatible. Both phases are homogeneous, and have their own Tg. Both Tgs are shifted from the values for the pure components towards a Tg which is a weighted average of the Tgs of the two individual components, as described by the Fox equation. An added component, called a compatibilizer, can make two thermoplastic compositions compatible. The compatibilizer can be either a separate copolymer made up of polymers from each of the two thermoplastic compositions, or it may be a compound containing functional groups with the ability to form compatible blends. An example of a compatible composition is the PC/ABS blends. In these blends, PC and the SAN phase of ABS partially dissolve in one another. In this case the interface is wide and the interfacial adhesion is good.

Fully immiscible compositions are characterized by a coarse morphology, sharp interface and poor adhesion between the phases. These compositions often require compatibilizers, which are additives, that when added to a composition of immiscible materials, modify their interfacial properties and stabilize the composition. Fully immiscible blends will exhibit different Tgs corresponding to the Tg of the respective original components and are not suitable for use with the present invention.

Of these compositions, compatible blends are preferred for use in association with the present invention. Compatibility or miscibility between the core and shell materials of the 3D printing filament is important to ensure that the core-shell structure does not introduce weakness as result of poor adhesion strength at the internal interface in the filament as manufactured. Poor interfacial adhesion often leads to delamination in a layered structure polymer product, such as multilayered filaments. Immiscible polymer blends or multilayered structures often require the assistance of a compatibilizer or an additional adhesion layer to provide sufficient adhesion between immiscible components to lead to desired mechanical properties. For miscible polymer components, however, adhesion is not an issue. In most cases, for co-extruded multilayered structures some mutual diffusion occurs across the interface during processing, melding the core and shell interface.

Experimental study of blend miscibility or compatibility is more difficult for polymeric materials than for small molecules, because the heat of mixing (ΔHm) is very small for polymers and is nearly impossible to measure directly. Because of the microscopic size of the dispersed phase, it is necessary to use special techniques to measure morphology on that very small scale. Measurement of the glass transition temperature of a blend is one of the most common ways to determine blend compatibility. Perhaps the most used criterion of polymer compatibility is the detection of a single glass transition whose temperature is commonly intermediate between the glass transition temperatures corresponding to each one of the blend components. Thus, a general rule that has been applied is that if the blend displays two Tgs at or near the same temperatures of the blend components, then the blend is classified as incompatible, unless a compatibilizer agent has been used. On the other hand, if the blend shows a single transition temperature that is intermediate between those of the pure components, the blend is classified as miscible. If the blend shows two Tgs shifted from those of the blend components towards each other, the blend is considered to be compatible.

2. Fabrication of 3D Printing Structured Filaments

The following materials were used to create the 3D printing structured filaments:

TABLE 1
Summary of materials, Tgs and viscosities (at shear rate of 70 s⁻¹)

| | | Printing | | | | |
|---|---|---|---|---|---|---|
| | Chemical | range | Tg | Viscosity (Pa · s) | | |
| Material | description | (° C.) | (° C.) | 280° C. | 300° C. | 325° C. |
| A | Copolycarbonate | 300-360 | 186 | 3246 | 1690 | 713 |
| B | PC/ABS blend | 240-280 | 105 | 292 | 157 | 74 |
| C | PC/ABS blend | 240-280 | 145 | 421 | 221 | 91 |
| D | Polycarbonate | 240-280 | 150 | 250 | 128 | 61 |
| E | Polycarbonate | 240-280 | 150 | 1905 | 940 | 408 |

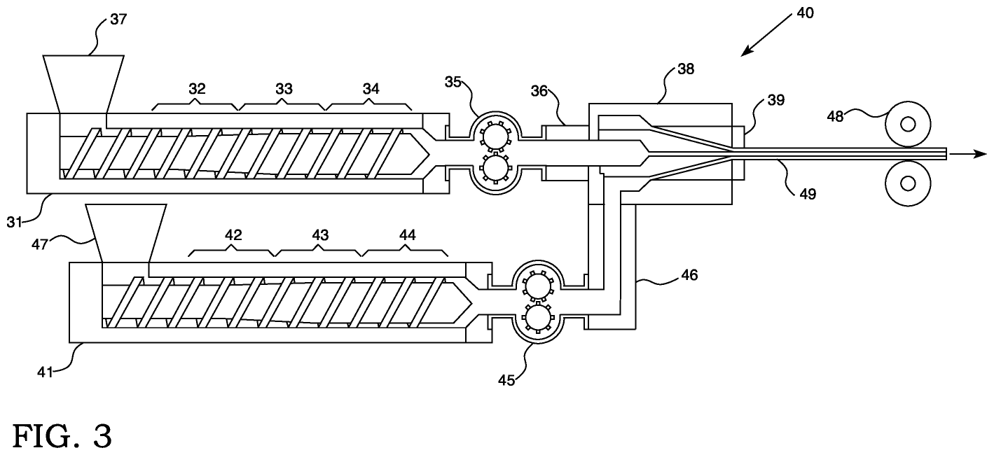

Structured filaments may be fabricated using a co-extrusion system, as illustrated in FIG. 3. The co-extrusion system 40 is composed of core extruder 31 and shell extruder 41. Core extruder 31 comprises three zones wherein the temperature may be controlled independently of one another, first zone 32, second zone 33 and third zone 34. Core extruder 31 further comprises melt pump 35 and die adaptor 36. Shell extruder 41 also comprises three zones wherein the temperature may be controlled independently of one another, or of any of the zones mentioned previously, first zone 42, second zone 43 and third zone 44. Shell extruder 41 further comprises melt pump 45 and die adaptor 46. Each extruder converts solid polymer pellets that are fed into fill cups 37 and 47, into a polymer melt for the chosen material. The melt pumps further pressurize and meter the melt into co-extrusion die 38. The two polymer melts meet at die 38 and nozzle 39 where the shell envelops the core to produce extruded structured filament 49, whose flow is assisted by traction system 48. This extrusion step-up enables continuous production of filaments with a core-shell structure. Such structured filaments may be added to a 3D printing element as shown in FIG. 2, as structured filament 28. The processing conditions for generating core-shell filaments are listed in Tables 2-4 below. The extrusion process temperatures were selected based on the process guidance provided by the manufacturer on the materials technical data sheet. These conditions are primarily the temperatures used for each section of the co-extrusion line.

TABLE 2
Extruder 1 (core)

| Material | Zone1 | Zone2 | Zone3 | Melt Pump |
|---|---|---|---|---|
| A | 280° C. | 295° C. | 310° C. | 320° C. |
| C | 220° C. | 235° C. | 250° C. | 260° C. |
| D | 290° C. | 275° C. | 260° C. | 275° C. |
| E | 300° C. | 290° C. | 280° C. | 290° C. |

TABLE 3
Extruder 2 (shell)

| Material | Zone1 | Zone2 | Zone3 | Melt Pump |
|---|---|---|---|---|
| A | 267° C. | 287° C. | 299° C. | 299° C. |
| B | 210° C. | 225° C. | 240° C. | 240° C. |
| C | 205° C. | 210° C. | 225° C. | 240° C. |
| D | 255° C. | 260° C. | 265° C. | 255° C. |

TABLE 4
Die

| Material | Die adaptor | Die adaptor | | |
|---|---|---|---|---|
| (core/shell) | (to core) | (to shell) | Die Body | Die Nozzle |
| A/C | 280° C. | 230° C. | 270° C. | 250° C. |
| A/B | 270° C. | 240° C. | 270° C. | 250° C. |
| E/B | 250° C. | 230° C. | 240° C. | 230° C. |
| D/B | 240° C. | 230° C. | 230° C. | 220° C. |
| E/D | 250° C. | 230° C. | 230° C. | 220° C. |
| B/A | 230° C. | 270° C. | 280° C. | 280° C. |

2a. Dimensions and Structure

The overall diameter of the co-extruded core-shell structured filaments was selected to be between 1.59 mm and 1.71 mm. The diameter was consistent along the length of all filaments. Measurements at several locations were made, and the diameter was found to have a maximum variation of 0.030 mm.

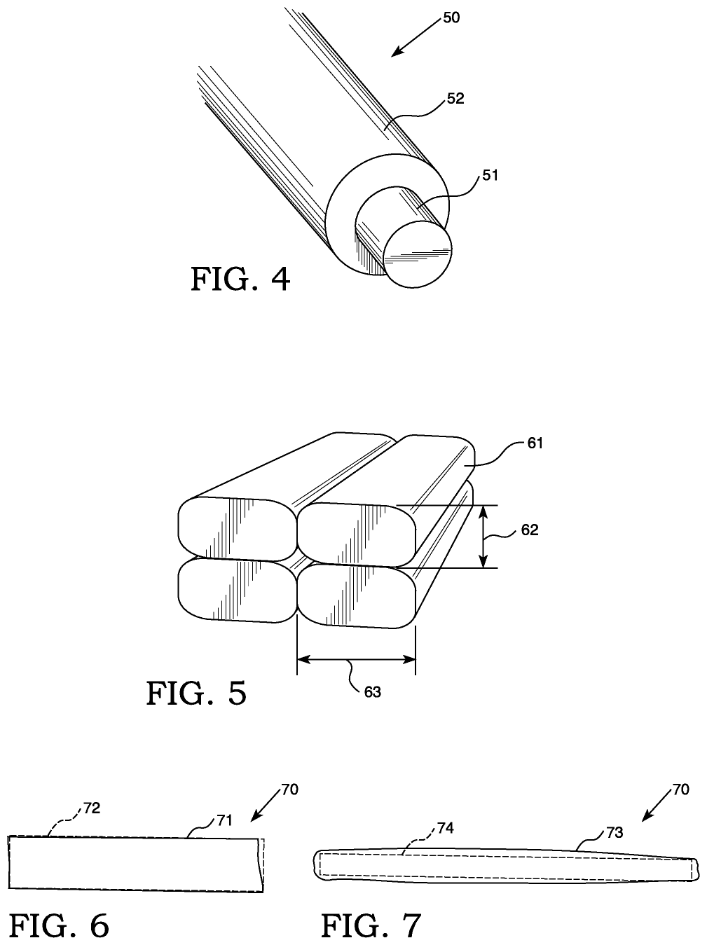

The co-extrusion process may produce, for example, cylindrical, concentric core-shell filaments. FIG. 4. shows a core-shell filament 50, comprised of core 51 and shell 52. This process allows for the volume ratio of the core and shell components to be systematically varied. Structured filaments with different core/shell volume ratios were fabricated where the volume of the core occupies preferably between 45% and 75%, and most preferably between 45% and 55%. The remainder of the filament's volume is occupied by the shell.

3. 3D Printing of Filaments

A Cartesio 3D printer is used, as it provides full control over the processing conditions for printing. Cartesio 3D printers are available from MaukCC, Maastricht, The Netherlands. The printer was modified to allow for improved printing of high temperature thermoplastics. First, the extruder nozzle on the Cartesio was replaced by a hot end nozzle that exhibits both better heat dissipation and switchable nozzle sizes to accommodate different diameter filaments and allow improved resolution or faster printing. Second, the heated bed, which consists of resistive heaters on glass, was replaced with an isolated aluminum plate with higher power resistive heaters. This switch increased the maximum bed temperature from 120° C. to 200° C.

3a. Printing Parameters

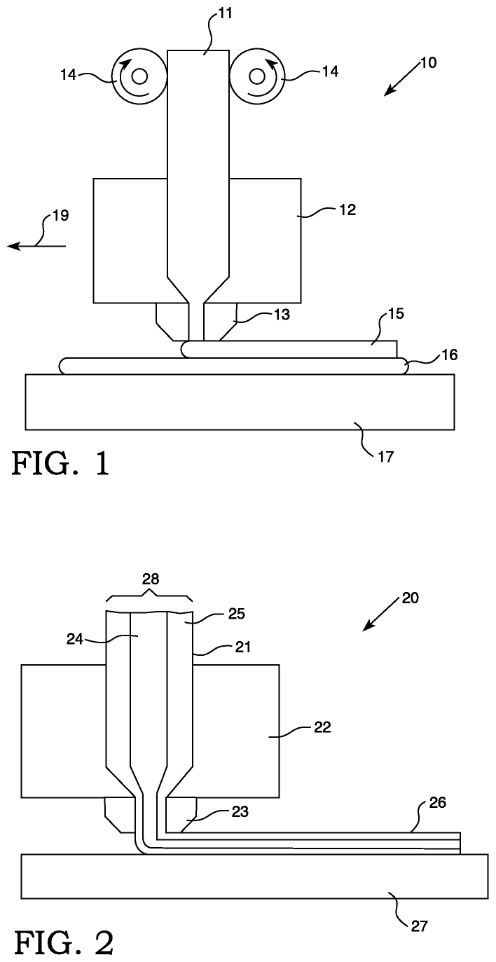

As shown in FIG. 1, the basic conditions that can be controlled during 3D printing relate to the extrusion process and parameters associated with x-y-z motion that impact the dimensions and orientation of the extruded material. The main extrusion variables for 3D printing element 10, are extrusion temperature (Tₑₓₜ), measured at heating element 12 and die 13, bed temperature (T_{bed}), measured at bed 17, and printing speed (U), shown as arrow 19, the speed of 3D printing element 10 depositing filament 15. Extrusion temperature (Tₑₓₜ) and printing speed (U) affect shear viscosity and flow rate of material inside the hot end. Selection of these variables is critical to enable a cohesive part to be printed. An appropriate print-bed temperature (T_{bed}) is necessary for the adhesion of the printed part to the print-bed. T_{bed} also impacts the temperature history of the printed part through modulating the cooling rate. As shown in FIG. 5, the dimensional variables provide the cross-sectional dimensions of extruded filament 61 through the layer height 62 (d) and extrudate width 63 (w). These two parameters also define the resolution of the part to be printed. The width is controlled by the diameter of the orifice in the nozzle and the feed rate of the filament into the printing element.

3b. Processing Window and Dimensional Fidelity

A different set of processing conditions must be used for printing each filament (including monofilaments and core-shell structured filaments) to obtain the best results in terms of mechanical/structural properties and dimensional fidelity of the printed part. It was found that the ideal set of conditions often involves a ‘processing window’ covering a range of inputs in the 3D printer, instead of a single value for each parameter. When a 3D printed object is created using a set of parameters within the processing window of the filament in use, its resulting mechanical/structural properties and dimensional fidelity are maximized. Minimal variance was observed when different sets of parameters within the processing window were used. When a 3D printed object is created outside of its processing window, its resulting mechanical and structural properties are poor compared to those of objects created within the processing window.

Printing parameters were used based on the individual materials properties including Tg and viscosity, and on the geometry expected for the final part. As it is known by someone skilled in the art, one can select a set of input parameters for each system to affect the way filaments and printed layers are assembled. In our experiments we used the following values for the 3D printing parameters: extrusion temperature Tₑₓₜ=310-325° C.; bed temperature T_{bed}=140-200° C.; layer height d=0.21 mm; extrudate width W=50-200% of the default extrudate width; extrusion speed U=40 mm/min; and printing orientation=0/90π or +450.

When a co-extruded structured filament is used for 3D printing, the range of processing parameters, referred here as ‘processing window’, is expanded in comparison to the processing parameters of its the single components. Particularly, the use of these core-shell filaments was found to significantly increase the range of extrusion and bed temperatures, over which parts with good mechanical properties and dimensional fidelity can be printed.

The dimensional fidelity of a 3D printed object is the ability to replicate the dimensions defined by the 3D digital model. Dimensional fidelity is quantified by the volume deviation of the actual 3D printed sample from its original 3D digital model:

$$\% {dev}_{from model} = ( \% {dev}_{side cross - section} + \% {dev}_{bottom cross - section} ) \times \frac{height model}{height sample}$$

$$\% {dev}_{c ross - section} = \vert \frac{Sample area - Model area}{Model area} \vert \times 100$$

For the determination of dimensional fidelity, a sample similar to an Izod impact bar (ASTM D256-10e1) is used. The digital model of this sample has dimensions on its width, length, and height. Measurements of the printed object may be taken using image processing software (for example imagej, an open source software tool available at www.imagej.net), and calculating the area of its side cross-section (width×length) and its bottom cross-section (length×height). FIG. 6. depicts a top view of printed sample 70, its measured (actual) cross-section area 71, with a superimposed cross-section area of its digital model 72, shown in dashed lines. FIG. 7 depicts a side view of the same printed sample 70, with its measured bottom-section area 73, and the bottom-section area of its digital model 74, also shown in dashed lines.

While a “processing window” for a filament, as noted above, may include several parameters, the bed temperature T_{bed}, has the greatest effect on the dimensional fidelity of the printed parts, and thus the processing window is defined herein in relation to the bed temperature. The limits of the processing window are defined by the range of T_{bed} that result in parts with deviation from geometry of less than 1.5% (high dimensional fidelity), and mechanical properties variance from part to part of less than one standard deviation from the average of all parts printed within the processing window.

### Measurement and Characterization Techniques

Tensile bars from both monofilaments and the core-shell filaments were printed and tested in accordance with ASTM D638-14 (Type V). The tensile tests were performed at an extension rate of 10 mm/min. The initial distance between the clamps was 25.4 mm. Strain at break, yield strain, elastic modulus and yield stress were measured.

The thermal analysis of these thermoplastic compositions was performed using a differential scanning calorimeter (TA Instruments DSC, Model Q2). The samples were hermetically sealed in aluminum pans and tested with a heating rate of 10° C./min from 30° C. to 250° C. under a nitrogen atmosphere. Differential scanning calorimetry is widely used to determine the amount of crystalline material. It can be used to determine the fractional amount of crystallinity in a polymer sample. Other commonly used methods are X-ray diffraction, density measurements, and infrared spectroscopy. In DSC, the weight fraction crystallinity is conventionally measured by dividing the enthalpy change associated with Tm, ΔHm (in Joules per gram), by the enthalpy of fusion for a 100% crystalline polymer sample, ΔHmo.

The rheological properties of the materials were measured using a capillary rheometer (Bohlin Instruments Model RH7). To prevent possible degradation induced by moisture at the molten state, all materials were dried in a vacuum oven at 110° C. for at least 24 hours prior to rheological measurements. For each thermoplastic composition, the properties were measured at three temperatures that were chosen based on the Tg of the polymer determined as discussed previously. All data were corrected for end pressure losses. Since FFF is a non-isothermal process, it is also important to assess the sensitivity of viscosity of the polymer components to temperature change. This assessment was performed by plotting the viscosity as a function of shear stress and selecting viscosities from three isothermally determined curves at a constant shear stress to fit into an Arrhenius-type analysis. For temperature ranges of 100° C. above the Tg, temperature dependence of the viscosity of polymer melts may be expressed in the form of Arrhenius Equation:

η=A·exp(Eₐ/RT)

Where η is the viscosity, R is the gas constant, A is a fitted constant, T is the absolute temperature, and Ea is called the activation energy of flow. Ea quantifies the sensitivity of the viscosity of polymer melt to temperature changes. The viscosity values were selected at 70 s⁻¹, typical shear rate of an extrusion process, to determine the Ea for all the materials. The Arrhenius equation was used to estimate the viscosity of the melt during printing in the cases where the printing temperature was outside the range of experimentally measured values.

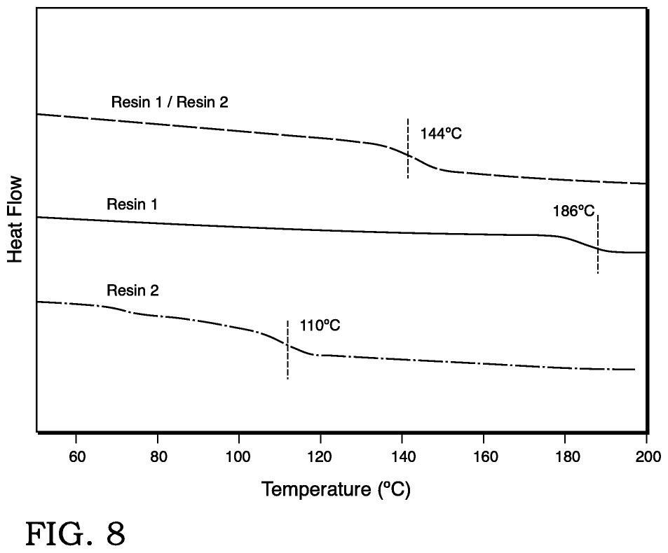

To test their compatibility, the different polycarbonate resins were blended by melt mixing in a HAAKE mini-compounder at 260° C. and 100 rpm for 5 min. The resultant blend was then examined using a TA Q200 DSC to determine the thermal properties of the blend. FIG. 8 illustrates the thermograms of a blend and its individual components. From these thermograms, the glass transition temperatures of resin 1 and resin 2 are 186° C. and 110° C. respectively. For 50:50 wt. ratio blend of resin 1/resin 2, a single glass transition temperature at 144° C. is observed instead of two separate glass transition temperatures associated to the individual components. This single transition temperature is indicative of compatibility of the two individual components.

### EXAMPLES

The tables below show the processing window, dimensional fidelity, and average strain at break of core-shell structured filaments A/B, E/B, C/B, D/B, E/D and B/A (core/shell) and of the monofilaments made from their individual materials A, B, C, D, and E.

TABLE 5

| | | | | | | Av. | |
|---|---|---|---|---|---|---|---|
| | | | | | Proc. | strain | |
| | | | V (Pa · s) | | window | at | Improvement |
| | | Tg or Δtg | or Vᵣₐₜᵢₒ | Text | T_{bed} | break | vs. |
| Example | Filament | (° C.) | (@ Tₑₓₜ)^{a} | (° C.) | (° C.) | (%)^{b} | monofilaments? |
| | Monofilaments | | | | | | |
| Comparative | A | 186 | 713 | 325 | N/A | N/A | — |
| A | | | | | | | |
| Comparative | B | 110 | 113 | 310 | 140-160 | 38.98 | — |
| B | | | | | | | |
| Comparative | C | 145 | 150 | 310 | 140-160 | 23.23 | — |
| C | | | | | | | |
| Comparative | D | 150 | 61 | 325 | ~160 | 41.08 | — |
| D | | | | | | | |
| Comparative | E | 150 | 408 | 325 | ~160 | 42.28 | — |
| E | | | | | | | |
| | Structured filaments (core/shell) | | | | | | |
| Example 1 | A/B | ΔTg = 76° C. | Vᵣₐₜᵢₒ = | 325 | 140-200 | 7.23 | Yes, proc. |
| | | | 9.64 | | | | window only |
| Example 2 | E/B | ΔTg = 40° C. | Vᵣₐₜᵢₒ = | 325 | 140-180 | 60.95 | Yes, proc. |
| | | | 5.51 | | | | window and |
| | | | | | | | strain at break |
| Example 3 | C/B | ΔTg = 35° C. | Vᵣₐₜᵢₒ = | 310 | 140-160 | 50.14 | Yes, strain at |
| | | | 1.33 | | | | break only |
| Comparative | D/B | ΔTg = 40° C. | Vᵣₐₜᵢₒ = | 325 | ~140 | 39.17 | No |
| example 4 | | | 0.82 | | | | |
| Example 5 | E/D | ΔTg = 0° C. | Vᵣₐₜᵢₒ = | 325 | ~160 | 47.83 | Yes, strain at |
| | | | 6.69 | | | | break only |
| Comparative | B/A | ΔTg = −76° C. | Vᵣₐₜᵢₒ = | 325 | ~180 | 7.63 | No |
| example 6 | | | 0.10 | | | | |

^{a}Viscosity or viscosity ratio at the most preferred Text for each filament
^{b}Average of the strain at break of samples printed within the processing window

### Example 1

| | | | Processing | | | | |
|---|---|---|---|---|---|---|---|
| | | | temperature | | V (Pa · s) | | Strain at |
| | | Tg or ΔTg | T_{bed} | Tₑₓₜ | or Vᵣₐₜᵢₒ | | break |
| No. | Filament | (° C.) | (° C.) | (°C.) | (@ Tₑₓₜ)^{a} | % dev_{frommodel} | (%) |

Core: monofilament A

| | | | | | | | |
|---|---|---|---|---|---|---|---|
| Comp A | A | 186 | 190 | 300 | 1690 | Not printable | — |
| | | | 190 | 325 | 713 | Not printable | — |
| | | | 190 | 350 | 302 | Not printable | — |
| | | | 215 | 300 | 1690 | Not printable | — |
| | | | 215 | 325 | 713 | 4.47 | 6.32 |
| | | | 215 | 350 | 302 | Not printable | — |

Shell: monofilament B

| | | | | | | | |
|---|---|---|---|---|---|---|---|
| Comp B | B | 110 | 130 | 310 | 113 | Not printable | — |
| | | | 140 | 310 | 113 | 0.00 | 48.16 |
| | | | 150 | 310 | 113 | 0.12 | 38.83 |
| | | | 160 | 310 | 113 | 0.49 | 29.95 |
| | | | 180 | 310 | 113 | 2.30 | 45.73 |
| | | | 150 | 325 | 74 | Not printable | — |

Structured filament (core/shell): A/B

| | | | | | | | |
|---|---|---|---|---|---|---|---|
| Ex 1 | A/B | ΔTg = 76° C. | 120 | 325 | Vᵣₐₜᵢₒ = 9.64 | Not printable | — |
| | | | 140 | 325 | Vᵣₐₜᵢₒ = 9.64 | 0.00 | 7.02 |
| | | | 150 | 325 | Vᵣₐₜᵢₒ = 9.64 | 0.00 | 5.62 |
| | | | 160 | 325 | Vᵣₐₜᵢₒ = 9.64 | 0.00 | 9.09 |
| | | | 170 | 325 | Vᵣₐₜᵢₒ = 9.64 | 0.00 | 6.21 |
| | | | 180 | 325 | Vᵣₐₜᵢₒ = 9.64 | 0.09 | 7.48 |
| | | | 190 | 325 | Vᵣₐₜᵢₒ = 9.64 | 0.50 | 6.91 |
| | | | 200 | 325 | Vᵣₐₜᵢₒ = 9.64 | 0.75 | 8.32 |
| | | | 215 | 325 | Vᵣₐₜᵢₒ = 9.64 | Not printable | — |

^{a}See Table 1

### Example 2

| | | | Processing | | | | |
|---|---|---|---|---|---|---|---|
| | | | temperature | | V (Pa · s) | | Strain at |
| | | Tg or ΔTg | T_{bed} | Tₑₓₜ | or Vᵣₐₜᵢₒ | | break |
| No. | Filament | (° C.) | (° C.) | (° C.) | (@ Text)^{a} | % dev_{frommodel} | (%) |

Core: monofilament E

| | | | | | | | |
|---|---|---|---|---|---|---|---|
| Comp. E | E | 150 | 140 | 325 | 408 | Not printable | — |
| | | | 160 | 325 | 408 | 0.36 | 42.28 |
| | | | 180 | 325 | 408 | 2.05 | 46.76 |
| | | | 200 | 325 | 408 | 4.72 | 46.89 |

Shell: monofilament B

| | | | | | | | |
|---|---|---|---|---|---|---|---|
| Comp. B | B | 110 | 130 | 310 | 113 | Not printable | — |
| | | | 140 | 310 | 113 | 0.00 | 48.16 |
| | | | 150 | 310 | 113 | 0.12 | 38.83 |
| | | | 160 | 310 | 113 | 0.49 | 29.95 |
| | | | 180 | 310 | 113 | 2.30 | 45.73 |
| | | | 150 | 325 | 74 | Not printable | — |

Structured filament (core/shell): E/B

| | | | | | | | |
|---|---|---|---|---|---|---|---|
| \ | E/B | ΔTg = 40° C. | 120 | 325 | Vᵣₐₜᵢₒ = 5.51 | Not printable | — |
| Ex. 2 | | | 140 | 325 | Vᵣₐₜᵢₒ = 5.51 | 0.00 | 47.44 |
| | | | 160 | 325 | Vᵣₐₜᵢₒ = 5.51 | 0.06 | 68.17 |
| | | | 180 | 325 | Vᵣₐₜᵢₒ = 5.51 | 1.48 | 67.24 |
| | | | 200 | 325 | Vᵣₐₜᵢₒ = 5.51 | 5.63 | 55.91 |

^{a}See Table 1

### Example 3

| | | | Processing | | | | |
|---|---|---|---|---|---|---|---|
| | | | temperature | | V (Pa · s) | | Strain at |
| | | Tg or ΔTg | T_{bed} | Tₑₓₜ | or Vᵣₐₜᵢₒ | | break |
| No. | Filament | (° C.) | (° C.) | (° C.) | (@ Tₑₓₜ)^{a} | % dev_{frommodel} | (%) |

Core: monofilament C

| | | | | | | | |
|---|---|---|---|---|---|---|---|
| Comp. C | C | 145 | 120 | 310 | 150 | Not printable | — |
| | | | 140 | 310 | 150 | 0.15 | 10.83 |
| | | | 150 | 310 | 150 | 0.42 | 12.49 |
| | | | 160 | 310 | 150 | 0.72 | 46.36 |
| | | | 180 | 310 | 150 | Not printable | — |

Shell: monofilament B

| | | | | | | | |
|---|---|---|---|---|---|---|---|
| Comp. B | B | 110 | 130 | 310 | 113 | Not printable | — |
| | | | 140 | 310 | 113 | 0.00 | 48.16 |
| | | | 150 | 310 | 113 | 0.12 | 38.83 |
| | | | 160 | 310 | 113 | 0.49 | 29.95 |
| | | | 180 | 310 | 113 | 2.30 | 45.73 |
| | | | 150 | 325 | 74 | Not printable | — |

Structured filament (core/shell): C/B

| | | | | | | | |
|---|---|---|---|---|---|---|---|
| Ex. 3 | C/B | ΔTg = 35° C. | 120 | 310 | Vᵣₐₜᵢₒ = 1.33 | Not printable | — |
| | | | 140 | 310 | Vᵣₐₜᵢₒ = 1.33 | 0.00 | 45.24 |
| | | | 160 | 310 | Vᵣₐₜᵢₒ = 1.33 | 1.43 | 55.04 |
| | | | 180 | 310 | Vᵣₐₜᵢₒ = 1.33 | Not printable | — |

^{a}See table 1

| | | | Processing | | | | |
|---|---|---|---|---|---|---|---|
| | | | temperature | | V (Pa · s) | | Strain at |
| | | Tg or ΔTg | T_{bed} | Tₑₓₜ | or Vᵣₐₜᵢₒ | | break |
| No. | Filament | (° C.) | (° C.) | (° C.) | (@ Text)^{a} | % dev_{frommodel} | (%) |

Core: monofilament D

| | | | | | | | |
|---|---|---|---|---|---|---|---|
| Comp. D | D | 150 | 140 | 325 | 61 | Not printable | — |
| | | | 160 | 325 | 61 | 1.07 | 41.08 |
| | | | 180 | 325 | 61 | 7.77 | 44.55 |
| | | | 200 | 325 | 61 | Not printable | — |

Shell: monofilament B

| | | | | | | | |
|---|---|---|---|---|---|---|---|
| Comp. B | B | 110 | 130 | 310 | 113 | Not printable | — |
| | | | 140 | 310 | 113 | 0.00 | 48.16 |
| | | | 150 | 310 | 113 | 0.12 | 38.83 |
| | | | 160 | 310 | 113 | 0.49 | 29.95 |
| | | | 180 | 310 | 113 | 2.30 | 45.73 |
| | | | 150 | 325 | 74 | Not printable | — |

Structured filament (core/shell): D/B

| | | | | | | | |
|---|---|---|---|---|---|---|---|
| Comp.. 4 | D/B | ΔTg = 40° C. | 120 | 325 | Vᵣₐₜᵢₒ = 0.82 | Not printable | — |
| | | | 140 | 325 | Vᵣₐₜᵢₒ = 0.82 | 0.76 | 39.17 |
| | | | 160 | 325 | Vᵣₐₜᵢₒ = 0.82 | 6.10 | 51.84 |
| | | | 180 | 325 | Vᵣₐₜᵢₒ = 0.82 | 17.48 | 50.12 |

^{a}See table 1

### Example 4

| | | | Processing | | | | |
|---|---|---|---|---|---|---|---|
| | | | temperature | | V (Pa · s) | | Strain at |
| | | Tg or ΔTg | T_{bed} | Tₑₓₜ | or Vᵣₐₜᵢₒ | | break |
| No. | Filament | (° C.) | (° C.) | (° C.) | (@ Tₑₓₜ)^{a} | % dev_{frommodel} | (%) |

Core: monofilament E

| | | | | | | | |
|---|---|---|---|---|---|---|---|
| Comp. E | E | 150 | 140 | 325 | 408 | Not printable | — |
| | | | 160 | 325 | 408 | 0.36 | 42.28 |
| | | | 180 | 325 | 408 | 2.05 | 46.76 |
| | | | 200 | 325 | 408 | 4.72 | 46.89 |

Shell: monofilament D

| | | | | | | | |
|---|---|---|---|---|---|---|---|
| Comp. D | D | 150 | 140 | 325 | 61 | Not printable | — |
| | | | 160 | 325 | 61 | 1.07 | 41.08 |
| | | | 180 | 325 | 61 | 7.77 | 44.55 |
| | | | 200 | 325 | 61 | Not printable | — |

Structured filament (core/shell): E/D

| | | | | | | | |
|---|---|---|---|---|---|---|---|
| Ex. 5 | E/D | ΔTg = 0° C. | 140 | 325 | Vᵣₐₜᵢₒ = 6.69 | Not printable | — |
| | | | 160 | 325 | Vᵣₐₜᵢₒ = 6.69 | 0.00 | 47.83 |
| | | | 180 | 325 | Vᵣₐₜᵢₒ = 6.69 | 3.17 | 46.43 |

^{a}See table 1

### Example 6

| | | | Processing | | | | |
|---|---|---|---|---|---|---|---|
| | | | temperature | | V (Pa · s) | | Strain at |
| | | Tg or ΔTg | T_{bed} | Tₑₓₜ | or Vᵣₐₜᵢₒ | | break |
| No. | Filament | (° C.) | (° C.) | (° C.) | (@ Tₑₓₜ)^{a} | % dev_{frommodel} | (%) |

Core: monofilament B

| | | | | | | | |
|---|---|---|---|---|---|---|---|
| Comp. B | B | 110 | 130 | 310 | 113 | Not printable | — |
| | | | 140 | 310 | 113 | 0.00 | 48.16 |
| | | | 150 | 310 | 113 | 0.12 | 38.83 |
| | | | 160 | 310 | 113 | 0.49 | 29.95 |
| | | | 180 | 310 | 113 | 2.30 | 45.73 |
| | | | 150 | 325 | 74 | Not printable | — |

Shell: monofilament A

| | | | | | | | |
|---|---|---|---|---|---|---|---|
| Comp. A | A | 186 | 190 | 300 | 1690 | Not printable | — |
| | | | 190 | 325 | 713 | Not printable | — |
| | | | 190 | 350 | 302 | Not printable | — |
| | | | 215 | 300 | 1690 | Not printable | — |
| | | | 215 | 325 | 713 | 4.47 | 6.32 |
| | | | 215 | 350 | 302 | Not printable | — |

Structured filament (core/shell): B/A

| | | | | | | | |
|---|---|---|---|---|---|---|---|
| Comp. 6 | B/A | ΔTg = −76° C. | 140 | 300 | Vᵣₐₜᵢₒ = 0.09 | Not printable | — |
| | | | 140 | 325 | Vᵣₐₜᵢₒ = 0.1 0 | Not printable | — |
| | | | 160 | 300 | Vᵣₐₜᵢₒ = 0.09 | Not printable | — |
| | | | 160 | 325 | Vᵣₐₜᵢₒ = 0.10 | Not printable | — |
| | | | 180 | 325 | Vᵣₐₜᵢₒ = 0.10 | 0.55 | 7.63 |
| | | | 200 | 325 | Vᵣₐₜᵢₒ = 0.10 | 3.85 | 7.91 |

^{a}See table 1

As noted above in Table 5, core-shell filaments in which the A Tg is greater than or equal to 0 and the Vᵣₐₜᵢₒ is >1 have either a broader processing window, improved mechanical properties, or both, compared with monofilaments of the same materials, or with core-shell filaments in which both the ΔTg and Vᵣₐₜᵢₒ conditions were not met.

Specifically, Example 1, where the ΔTg and Vᵣₐₜᵢₒ are 76° C. and 9.64, respectively, showed an improvement in processing window over both monofilaments A and B. Example 2, where the ΔTg and Vᵣₐₜᵢₒ were 40° C. and 5.51, respectively showed both a significant increase of the processing window and strain at break for the structured filament, in comparison with its individual core and shell materials. These two examples both fulfill the conditions of ΔTg> or equal to 0° C. and Vᵣₐₜᵢₒ>1.

Examples 3 and 5, which have A Tgs of 35 and 0° C. and Vᵣₐₜᵢₒₛ of 1.33 and 6.69, respectively show no significant improvement of the processing window for the structured filament, in comparison with its individual core and shell materials. However, in both cases increase in strain at break in parts prepared from the structured filament, compared with parts from either monofilament was observed. Comparative Example 4 shows a narrowing of the processing window for the structured filament, in comparison with its individual core and shell materials. Although the ΔTg of 40° C. meets the requirement of the invention, the Vᵣₐₜᵢₒ of 0.82 falls outside of the scope of our claims. This Vᵣₐₜᵢₒ indicates the viscosity of the shell is greater than that of the core at the printing temperature, which results in a detrimental effect on the printability of the structured filament.

Finally, Comparative Example 6, describes a core-shell filament with a ΔTg of

−76° C. and a Vᵣₐₜᵢₒ of 0.10. In this case, neither the ΔTg nor Vᵣₐₜᵢₒ requirement of the invention is met. This example shows significant narrowing of the processing window and no improvement in strain at break for the core-shell filament, in comparison with its individual core and shell materials.

The following aspects of the present invention are summarized:
1. A 3D printing filament comprising:
a core thermoplastic extrudate, having an outside surface, a glass transition temperature Tg-core, and a viscosity at printing temperature V-core; and
a shell thermoplastic extrudate, having an inside and an outside surface, a glass transition temperature Tg-shell, and a viscosity at printing temperature V-shell,
wherein the outer surface of the core thermoplastic polymer is in contact with the inner surface of the shell thermoplastic polymer,
wherein Tg-core is greater than or equal to Tg-shell, and
wherein the ratio of V-core/V-shell is greater than 1 and a maximum of 20, and
wherein the core and shell thermoplastic extrudates are miscible or compatible with each other.
2. A 3D printing filament comprising:
a core thermoplastic extrudate, having an outside surface, a glass transition temperature Tg-core, and a viscosity at printing temperature V-core; and
a shell thermoplastic extrudate, having an inside and an outside surface, a glass transition temperature Tg-shell, and a viscosity at printing temperature V-shell,
wherein the outer surface of the core thermoplastic polymer is in contact with the inner surface of the shell thermoplastic polymer,
wherein Tg-core is greater than or equal to Tg-shell, and
wherein the ratio of V-core/V-shell is greater than 1 and a maximum of 20, and wherein each of the core and shell thermoplastic extrudates comprise a polymer selected from the group consisting of polycarbonates, polyurethanes, polyesters, acrylonitrile butadiene styrene, styrene acrylonitrile, polyalkyl methacrylate, polystyrene, polysulfone, polylactic acid, polyetherimide, and polyimides.
3. The 3D printing filament of any of the preceding aspects, wherein Tg-core and Tg-shell are between 25° C. and 325° C., preferably between 90° C. and 220° C., most preferably between 110° C. and 190° C.
4. The 3D printing filament of any of the preceding aspects, wherein Tg-core is equal to Tg-shell.
5. The 3D printing filament of any of the preceding aspects, wherein Tg-core is greater than Tg-shell, in an amount greater than 0° C., up to 100° C., preferably in an amount between 30° C. and 90° C.
6. The 3D printing filament of any of the preceding aspects, wherein the ratio of V-core/V-shell is between 1 and 15, preferably between 1 and 10.
7. The 3D printing filament of any of the preceding aspects, wherein the filament comprises 35%-75%, preferably 45%-55%, core thermoplastic extrudate.
8. The 3D printing filament of any of the preceding aspects, wherein substantially all of the inner surface of the shell thermoplastic polymer is in contact with the outer surface of the core.
9. The 3D printing filament of any of the preceding aspects, wherein substantially all of the outer surface of the core thermoplastic polymer is in contact with the inner surface of the shell thermoplastic polymer.
10. The 3D printing filament of any of the preceding aspects, wherein the core and shell thermoplastic extrudates each have a crystallinity of 10% or less.

What is claimed is:

1. A 3D printing filament comprising:
a core thermoplastic extrudate, having an outside surface, a glass transition temperature Tg-core, and a viscosity at printing temperature V-core; and
a shell thermoplastic extrudate, having an inside and an outside surface, a glass transition temperature Tg-shell, and a viscosity at printing temperature V-shell,
wherein the outer surface of the core thermoplastic polymer is in contact with the inner surface of the shell thermoplastic polymer,
wherein Tg-core is greater than or equal to Tg-shell, and
wherein the ratio of V-core/V-shell is greater than 1 and a maximum of 20, and
wherein the core and shell thermoplastic extrudates are miscible or compatible with each other.

2. The 3D printing filament of claim 1, wherein Tg-core and Tg-shell are between 25° C. and 325° C.

3. The 3D printing filament of claim 2, wherein Tg-core and Tg-shell are between 90° C. and 220° C.

4. The 3D printing filament of claim 3, wherein Tg-core and Tg-shell are between 110° C. and 190° C.

5. The 3D printing filament of claim 1, wherein Tg-core is equal to Tg-shell.

6. The 3D printing filament of claim 1, wherein Tg-core is greater than Tg-shell, in an amount greater than 0° C., up to 100° C.

7. The 3D printing filament of claim 6, wherein Tg-core is greater than Tg-shell, in an amount between 30° C. and 90° C.

8. The 3D printing filament of claim 1, wherein the ratio of V-core/V-shell is between 1 and 15.

9. The 3D printing filament of claim 8, wherein the ratio of V-core/V-shell is between 1 and 10.

10. The 3D printing filament of claim 1, wherein the filament comprises 35%-75% core thermoplastic extrudate.

11. The 3D printing filament of claim 10, wherein the filament comprises 45%-55% core thermoplastic extrudate.

12. The 3D printing filament of claim 1, wherein substantially all of the inner surface of the shell thermoplastic polymer is in contact with the outer surface of the core.

13. The 3D printing filament of claim 1, wherein substantially all of the outer surface of the core thermoplastic polymer is in contact with the inner surface of the shell thermoplastic polymer.

14. The 3D printing filament of claim 1, wherein the core and shell thermoplastic extrudates each have a crystallinity of 10% or less.

15. A 3D printing filament comprising:
a core thermoplastic extrudate, having an outside surface, a glass transition temperature Tg-core, and a viscosity at printing temperature V-core; and
a shell thermoplastic extrudate, having an inside and an outside surface, a glass transition temperature Tg-shell, and a viscosity at printing temperature V-shell,
wherein the outer surface of the core thermoplastic polymer is in contact with the inner surface of the shell thermoplastic polymer,
wherein Tg-core is greater than or equal to Tg-shell, and
wherein the ratio of V-core/V-shell is greater than 1 and a maximum of 20, and
wherein each of the core and shell thermoplastic extrudates comprise a polymer selected from the group consisting of polycarbonates, polyurethanes, polyesters, acrylonitrile butadiene styrene, styrene acrylonitrile, polyalkyl methacrylate, polystyrene, polysulfone, polylactic acid, polyetherimide, and polyimides.

16. The 3D printing filament of claim 15, wherein Tg-core and Tg-shell are between 25° C. and 325° C.

17. The 3D printing filament of claim 16, wherein Tg-core and Tg-shell are between 90° C. and 220° C.

18. The 3D printing filament of claim 17, wherein Tg-core and Tg-shell are between 110° C. and 190° C.

19. The 3D printing filament of claim 15, wherein Tg-core is equal to Tg-shell.

20. The 3D printing filament of claim 15, wherein Tg-core is greater than Tg-shell, in an amount greater than 0° C., up to 100° C.

21. The 3D printing filament of claim 20, wherein Tg-core is greater than Tg-shell, in an amount between 30° C. and 90° C.

22. The 3D printing filament of claim 15, wherein the ratio of V-core/V-shell is between 1 and 15.

23. The 3D printing filament of claim 22, wherein the ratio of V-core/V-shell is between 1 and 10.

24. The 3D printing filament of claim 15, wherein the filament comprises 35%-75% of the core.

25. The 3D printing filament of claim 24, wherein the filament comprises 45%-55% of the core.

26. The 3D printing filament of claim 15, wherein substantially all of the inner surface of the shell thermoplastic polymer is in contact with the outer surface of the core.

27. The 3D printing filament of claim 15, wherein substantially all of the outer surface of the core thermoplastic polymer is in contact with the inner surface of the shell thermoplastic polymer.
